(19) United States
(12) Patent Application Publication
(10) Pub. No.: US 2015/0083498 A1
(43) Pub. Date: Mar. 26, 2015

(54) ELECTRICAL CONDUCTOR SUBASSEMBLY AND METHOD OF USE

(71) Applicants: Anthony DOHERTY, (US); Peter BOURKE, (US)

(72) Inventors: Anthony Doherty, Eltham (AU); Peter Bourke, Traralgon (AU)

(21) Appl. No.: 14/383,913

(22) PCT Filed: Mar. 22, 2013
(86) PCT No.: PCT/AU2013/000282

§ 371 Date: Sep. 9, 2014

(30) Foreign Application Priority Data
Mar. 23, 2012 (AU) 2012901173

(51) Int. Cl. H01B 7/00; E21B 7/04; H01R 43/26; E21B 17/00; H01R 4/22; H01R 33/965

(52) U.S. Cl. CPC H01B 7/0072; H01R 4/22; H01R 33/965; H01R 43/26; E21B 17/003; E21B 7/046
USPC 175/57; 174/47; 29/876

(57) ABSTRACT

The invention provides an electrical conductor subassembly and a method of constructing an isolated electrical connection comprising a set of the connected electrical conductor subassemblies. Each subassembly is connectable with other of the subassemblies into a conductor string while being fed into an opening in a hole or pipe, thereby enabling an electrical connection along the conductor string that is electrically substantially isolated from external fluids in the hole or pipe. Each conductor subassembly comprises: a conductor segment with a conductor core surrounded by an insulating layer; two connectors attached to opposite ends of the conductor segment, having two respective conductor engagement elements attached to corresponding ends of the conductor core. The connectors of adjacent conductor subassemblies are connectable securely against forces in the hole or pipe and so as to electrically join their corresponding conductor engagement elements and seal them from contact with the external fluids.

### FIELD

The present invention relates to the operation of electrical equipment in holes or pipes, in particular but not limited to the supply of isolated electrical connection to a device located down a hole or pipe.

### BACKGROUND

There are many circumstances in which it is desired to provide an isolated electrical connection to a device in a hole or pipe. Typically, the electrical connection is fed from an opening at the surface where the drilling is performed. In the field of guided horizontal directional drilling techniques, which are used in the trenchless installation of underground utilities such as electric and telephone cables and water, sewage and gas lines as well as river crossings, it is advantageous to provide an isolated electrical connection to the drill head, where a transmitter is located that provides information on the position of the drill. The electrical connection provides power and/or data communication between the surface and the drill head. The prior art method of providing such an electrical connection is to use sections of cable which are spliced together manually by an operator as the drill progresses into the earth and additional sections of drill pipe are added to the drill string.

The practice of splicing cable together is a time-consuming operation, which results in poor isolation of the electrical current from the influence of fluids in the drill pipe. One solution to this problem has been provided by Digital control Inc which invented the Cablelink® connection system, whereby an isolated electrical path is provided by an insert fitted in each drill pipe disposed around the inside surface of the drill pipe, and an electrical connection is automatically made as the drill pipe segment is screwed into and adjacent drill pipe segment to extend the drill string.

While this solution is appealing, in practice the connections are somewhat unreliable and the apparatus disposed inside the drill pipe segments substantially impede the flow of fluids. In addition, the insert is expensive and cannot be removed in situ.

There is therefore a need for an improved method of providing an isolated electrical connection along holes or pipes, particularly drill strings used in the trenchless construction industry.

### SUMMARY OF THE INVENTION

According to a first broad aspect of the invention there is provided an electrical conductor subassembly connectable with other of the subassemblies into a conductor string while being fed into an opening in a hole or pipe, thereby enabling an electrical connection along the conductor string that is electrically substantially isolated from external fluids in the hole or pipe, each conductor subassembly comprising:

a conductor segment with a conductor core surrounded by an insulating layer;

first and second connectors attached to opposite ends of the conductor segment, having respective first and second conductor engagement elements attached to corresponding ends of the conductor core;

wherein the first and second connectors of adjacent conductor subassemblies are connectable securely against forces in the hole or pipe and so as to electrically join the corresponding first and second conductor engagement elements and seal them from contact with the external fluids.

In one embodiment, the hole or pipe is a drill pipe string for use in trenchless construction, the drill pipe string being constructed from drill pipe segments screwed together into the drill pipe string as a drill head bores through the earth; and the opening is an end of a last-screwed drill pipe segment.

In one embodiment, the first and second connectors when joined are prevented from relative rotation.

In one embodiment, a cross-sectional area of the conductor segment is substantially less than an internal cross-sectional area of the drill pipe so as not to substantially impede flow of the fluids.

In one embodiment, the conductor segment is sufficiently rigid to resist tangling in use. Preferably, the conductor segment is sufficiently flexible to allow insertion through a gap between the last-screwed drill pipe segment and a drill pipe segment loaded onto a drill rig.

In one embodiment, a maximum lateral dimension of the first and second connector is also substantially less than an internal cross-sectional area of the drill pipe.

In one embodiment, the first and second connectors are lockable together by operation of a locking element.

In one embodiment, the rigid conductor segment is a rigid or rigidified segment of cable.

In one embodiment, the subassembly further comprises an o-ring seal disposed in the first or second connector to seal the conductor engagement elements from the outside fluids.

In one embodiment, the conductor core is suitable for transmitting electrical power and/or receiving data signals from a device attached at a distal end of the conductor string.

In one embodiment, the conductor core is suitable for transmitting electrical power and/or receiving data signals from a drill head attached at a distal end of the conductor string.

In one embodiment, a length of the subassembly is substantially the same as a length of each drill pipe segment, to allow connection of the subassembly to the conductor string as each drill pipe segment is screwed into the drill pipe. The drill pipe segments may have an internal diameter of less than 20 cm, the length of each drill pipe segment may be less than 200 cm, and the rigid conductor segment may comprise a rigid cable having a diameter of less than 2 cm.

According to a second broad aspect of the invention there is provided a method of constructing an isolated electrical connection comprising a set of the connected electrical conductor subassemblies of the first broad aspect to a device in a drill pipe for use in trenchless construction, the method comprising the steps of joining and locking together the first and second connectors of adjacent subassemblies to form the conductor string.

According to a third broad aspect of the invention there is provided a method of constructing an isolated electrical connection comprising a set of the connected electrical conductor subassemblies of the first broad aspect to a device in a drill pipe for use in trenchless construction, the method comprising the steps of:

connecting at least a first one of the subassemblies to the device so that a rearmost connector of the first subassembly is accessible from the end of a last-screwed drill pipe segment;

operating the drill until a new drill pipe segment needs to be screwed into the drill pipe string;

connecting at least a further one of the subassemblies by connecting the appropriate connectors of the further subassembly to the rearmost connector of the first subassembly;

screwing the new drill pipe segment into the drill pipe string so as to encompass the further subassembly and so that a rearmost connector of the conductor string thus formed is accessible from the open end of the new drill pipe segment; and

repeating the steps of operating the drill, connecting a further one of the subassemblies and screwing the new drill pipe segment as required.

Typically, the step of connecting at least a further one of the subassemblies comprises inserting each further one of the subassemblies through a gap between the last-screwed drill pipe segment and a drill pipe segment loaded onto a drill rig

### BRIEF DESCRIPTION OF DRAWINGS

FIG. 1 is a cross sectional depiction of a drill rig and drill string inside which a conductor string in accordance with an embodiment of the current invention has been assembled and installed.

FIG. 2 is a lateral view of an electrical conductor subassembly according to an embodiment of the current invention;

FIG. 3 is a cross sectional view of a rigid conductor segment of the electrical conductor subassembly in accordance with the embodiment of FIG. 2;

FIG. 4 is a perspective view of the first and second connectors of adjacent electrical conductor subassemblies connected together, together with a retaining clip.

FIG. 5a is a perspective view of the first connector of an electrical conductor subassembly according to the embodiment of FIG. 2;

FIG. 5a is a side view of the first connector of FIG. 5a;

FIG. 5C is a top view of the first connector of FIG. 5a;

FIG. 5d is a mid-cross sectional top view of the first connector of FIG. 5a, with the rigid conductor segment installed;

FIG. 6a is a perspective view of the second connector of the electrical conductor subassembly of FIG. 2;

FIG. 6c is a side view of the second connector of FIG. 6a;

FIG. 6c is a top view of the second connector of FIG. 6a;

FIG. 6d is a cross-section through a top view of the second connector of FIG. 6a, with the rigid conductor segment installed;

### DETAILED DESCRIPTION OF EMBODIMENTS

An embodiment of the current invention will now be described.

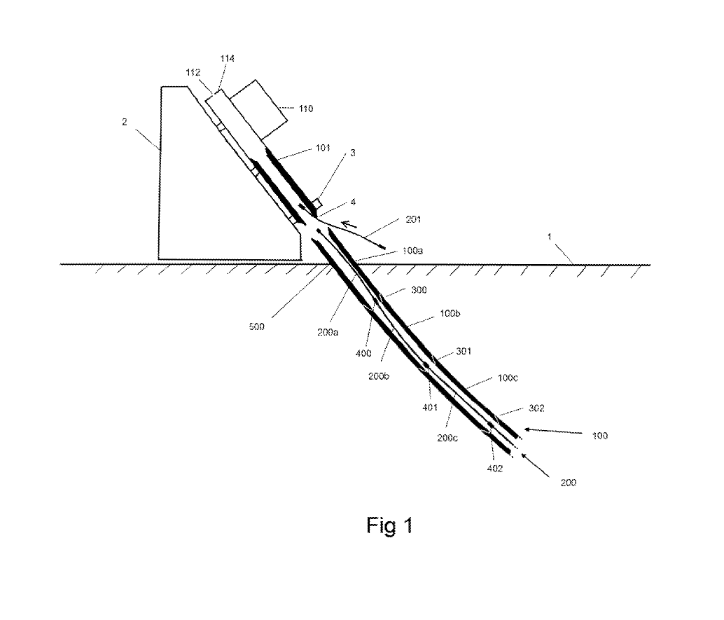

Referring first to FIG. 1, an upper portion of a drill string 110 is shown entering the ground 1 at an opening 500. Drill rig 2 has a drill pipe segment 101 held by a clamp 3 ready for screwing into the last screwed drill pipe segment 100a. The diagram proportions are exaggerated, and in reality the drill pipe segment is typically at about 12 degrees inclination from horizontal, and the drill pipe segments appear much thicker in the figure, in reality being several metres in length and only about 200 mm in diameter. As the drill head bores into the ground guided by a positional sensor in the drill head (not shown) sections 108, 100 B, 100 C, of internal diameter 20 mm-100 mm and length 3 m-10 m are added to the drill string at ground level, joined together by tapered screw joints 300, 301, 302. According to the invention, insulated conductor string 200 is assembled in situ from electrical conductor subassemblies 200a, 200b, 200c joined at their connectors shown at 400,401,402 and each subassembly being added to the drill string at the same time as the drill pipe sections are added at the surface, in much the same manner as the spliced cable sections of the prior art are added. Normal use of the system involves connecting a first one of the subassemblies to the device so that a rearmost connector of the first subassembly is accessible from the end of the last-screwed drill pipe segment, operating the drill until a new drill pipe segment needs to be screwed into the drill pipe string, connecting a further one of the subassemblies 201 by connecting the appropriate connectors of the further subassembly to the rearmost connector the first subassembly, screwing the new drill pipe segment into the drill pipe string so as to encompass the further subassembly and so that a rearmost connector of the conductor string thus formed is accessible from the open end of the new drill pipe segment, and repeating the steps of operating the drill, connecting a further one of the subassemblies and screwing the new drill pipe segment as required. Typically, referring to FIG. 1, the step of connecting the further one of the subassemblies comprises feeding a new subassembly 201 through a gap 4 of about 200 mm between the last-screwed drill pipe segment 100a and the drill pipe segment 100a loaded onto the drill rig held by clamp 3, as shown in progress in the figure. The subassemblies in this embodiment are sufficiently flexible to allow this manipulation. An alternative means of connecting the new subassembly 201 is to feed in through the top end of drill pipe segment 101 through aperture 112 located at an end 114 of the rig. When there is a need for establishing the electrical connection and operating the powered device at the drill head, a specially short subassembly may be attached to a segment 201 first before feeding in, preferably through gap 4, so that the conductor string can extend a convenient distance out through aperture 112 past gearbox 110. Aperture 112 may then be glanded and sealed against the cable, and power delivered to the conductor string from outside aperture 112 to operate the powered device.

Because in this embodiment the cross-sectional area of the conductor segment and the connectors is substantially less than the cross-sectional area of the drill pipe, flow of fluids in the pipe is not substantially impeded.

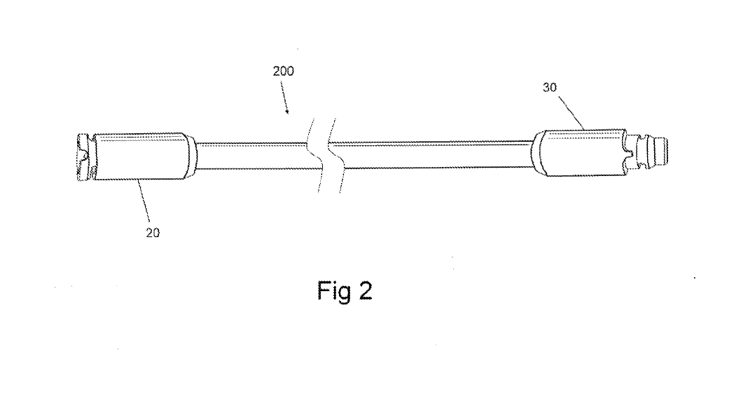

Referring now to FIG. 2, an electrical conductor subassembly according to an embodiment of invention is shown in side view. A semi-rigid conductor segment in the form of a semi-rigid cable 40 is terminated at one end by a first connector 20, and at an opposite end by a second connector 30. Connectors 20 and 30 are machined from brass, stainless steel or other suitable tough material. The length of rigid cable 40 and attached connectors 20 and 30 is approximately substantially the same as the length of drill pipe sections (3 m-10 m) so that the electrical conductor subassemblies can be connected in coordination with addition of drill pipe sections. The cable 40 is rigid enough to resist tangling (such as doubling up) in the drill pipe in use, but flexible enough to allow insertion and connection as described above.

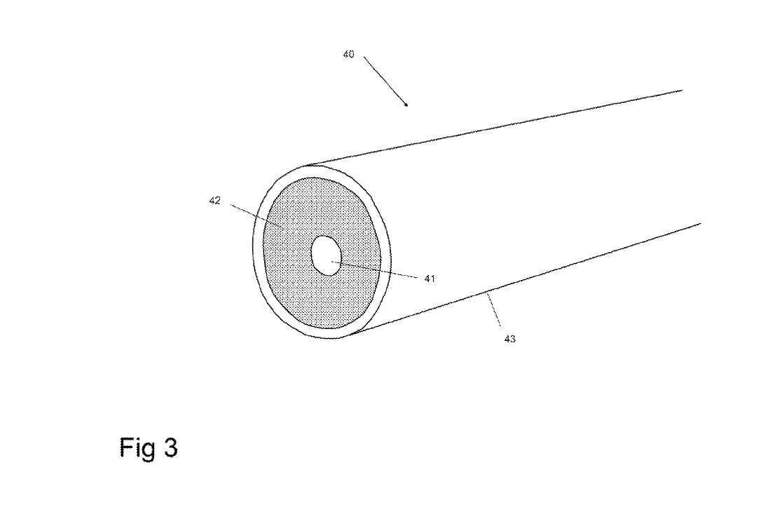

Referring now to FIG. 3, a cross section through rigid cable 40 shows solid copper conductor core 41 of cross-sectional area approximately 6 mm² surrounded by insulator layer 42 composed of fibreglass of outer diameter about 8 millimetres (typically less than 14 mm), which in turn is covered by an outer polyethylene jacket 43 of thickness approximately 1 mm (typically up to 1.5 mm).

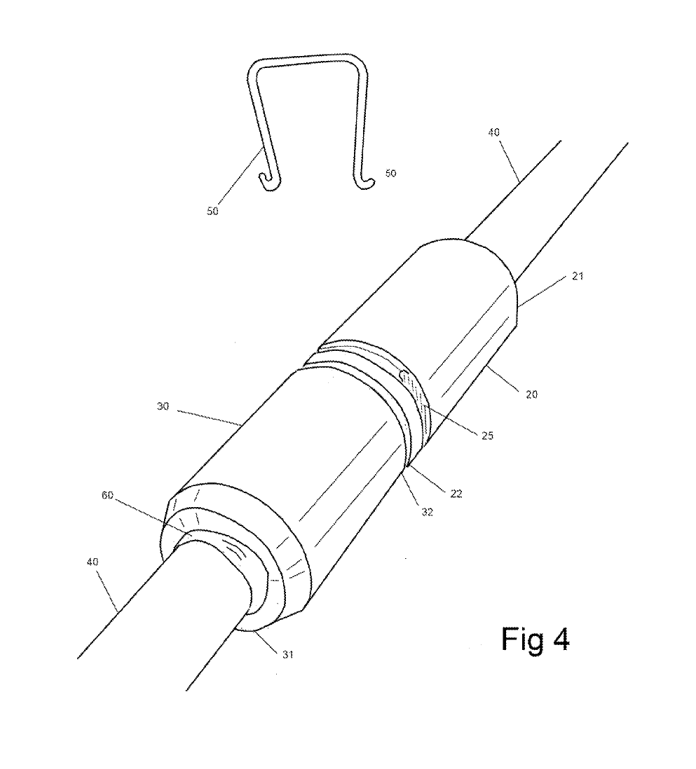

Referring now to FIG. 4, a perspective view of two electrical conductor subassemblies at their connection point is shown. Rigid cable 40 of one subassembly is terminated in the first connector 20 comprising first distal end 21 and first proximal surface 22. Insulated cable 40 of an adjacent subassembly is terminated in second connector 30 having second distal end 31 and second proximal surface 32. The two connectors are joined during use with the proximal surface 22 and 32 opposing each other. Waterproof glue 60 is used during manufacture of the subassembly to seal and fix the connectors 30 and 20 on to the cable 40. Retaining clip 50 is inserted into retaining slots 25 after positioning of the connectors to lock them together, explained further in the following.

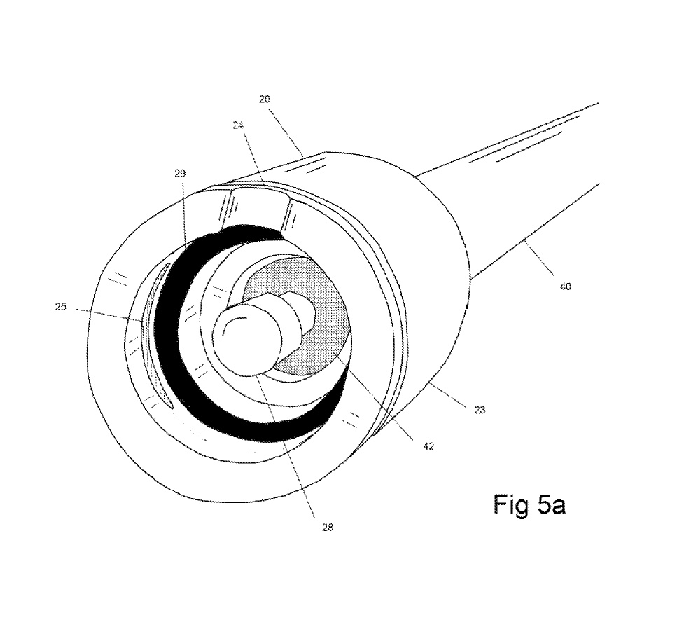

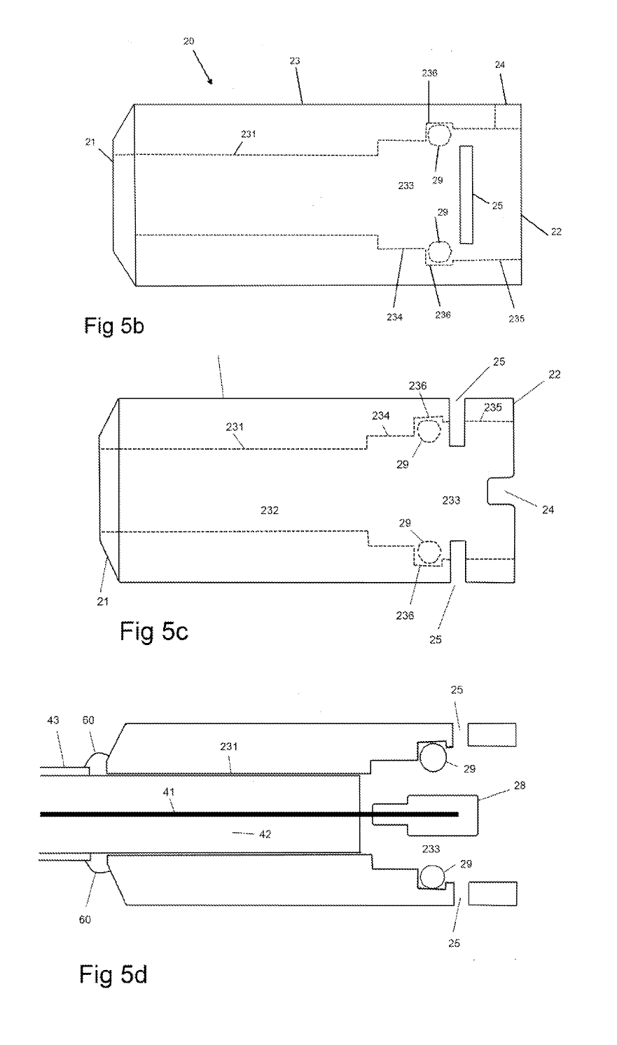

Referring now to FIG. 5a, first connector 20 of an electrical conductor subassembly 200 is shown in perspective view, revealing first conductor engagement element 28 protruding from an exposed end of the conductor core, o-ring 29 providing sealing against external fluids, slot 25 for receiving retaining clip 50 and notch 24 for preventing relative rotation of the first and second connectors after joining.

Referring now to FIG. 5b, assigned a few of the first connector is shown. The connector has a first Helter cylindrical surface 23 and a first inner cylindrical surface 231 for receiving the cable stripped of its outer jacket 43. Conductor engagement chamber 23 is holding the first conductor engagement element 28, and for receiving the second connector. O-ring 29 provides sealing and is disposed in o-ring groove 236.

Referring now to FIG. 5c, which is a top view of the the first connector, slots 25 can be seen on either side and a notch 24 for receiving a corresponding lug on the second connector to prevent relative rotation of the first connector and the second connector.

Referring now to FIG. 5d, which from the same top orientation as FIG. 5c but in cross-section, showing conductor 40 with jacket 43 removed and insulation layer 42 engaging with the first inner cylindrical surface 231. First conductor engagement element 28 is a shaped conducting contactor encompassing the exposed end of conduct a core 41 and projecting into conduct engagement chamber 233. Waterproof glue 60 fixes the cable in place and seals the conductor engagement element 28 from external fluids when joined in use, in conjunction with the operation of o-ring 29.

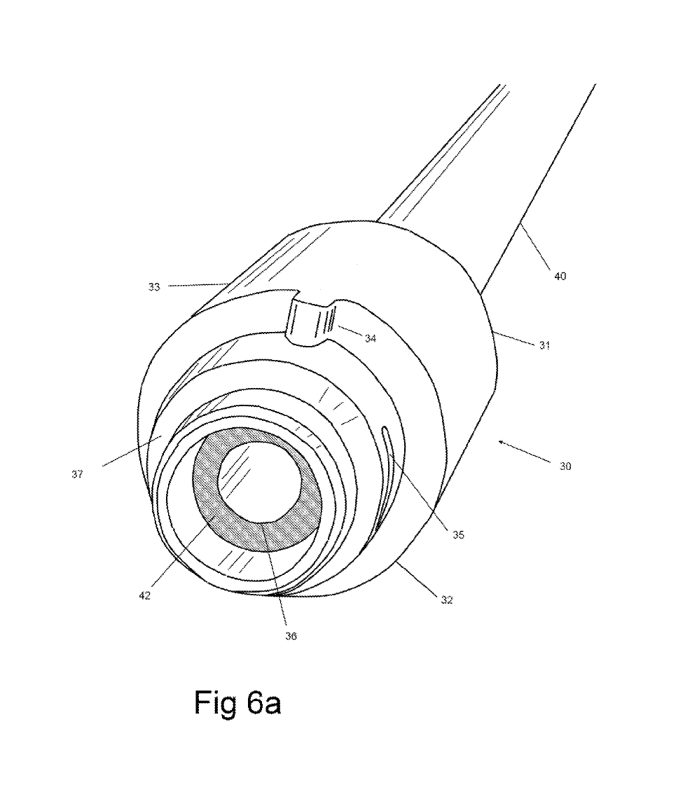

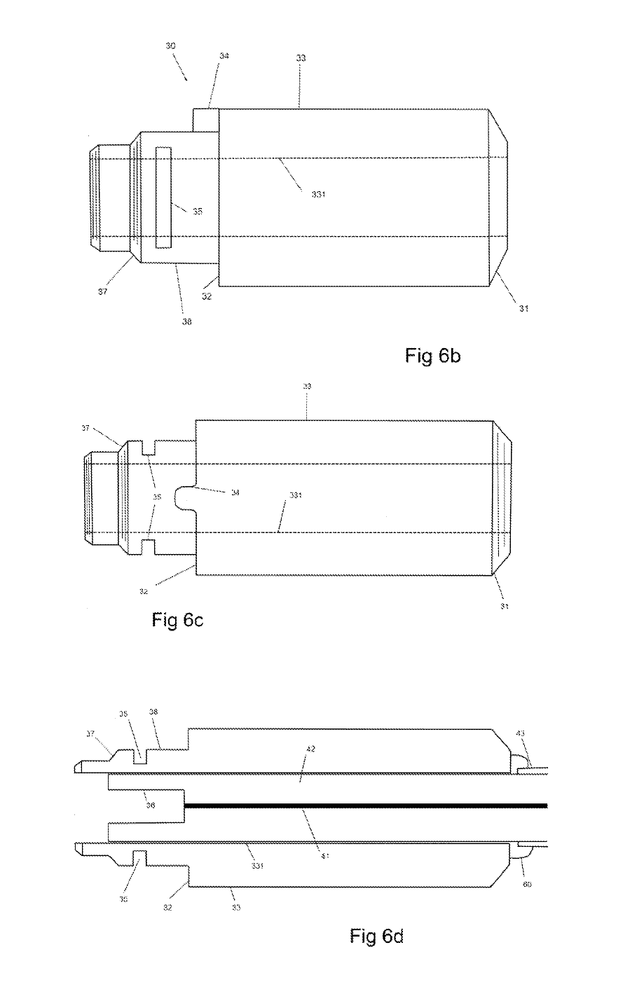

Referring now to FIG. 6a, a perspective view of second connector 30 is shown, comprising second distal end 31, and second conductor engagement element 36 embedded in an exposed end of insulator layer 42. Bevelled o-ring engagement surface 37 is adapted to engage with o-ring 29 when connected to the first connector. Lug 34 is adapted to engage with notch 24 of the first connector, as previously discussed. Grooves 35 are adapted to cooperate with slots 25 to provide a passage for insertion of the retaining clip 50 which prevents removal of the first and second connectors after joining. Grooves 35 are positioned so that, when lined up with slots 35, the o-ring 20 is compressed onto its seat.

Referring now to FIG. 6b, where a side view of the second connector is shown, retaining groove 35 is visible as is bevelled O-ring engagement surface 37. Second inner cylindrical surface 331 extends throughout the second connector and is adapted to receive an end of cable 40 stripped of jacket 43.

Referring now to FIG. 6c, where a top view of the second connector is shown, retainer grooves 35 can be seen on either side and lug 34 at top centre.

Referring now to FIG. 6d, the same orientation as FIG. 6C can be seen except with a cross sectional review, showing installed conductor segment with exposed insulation layer 42 and conductor 41. At the end of the conductor segment a second conductor engagement element 36 comprising a metal cylinder is installed inside a recess bored out of insulation layer 42. Second conductor engagement element 36 is adapted to engage with first conducted engagement element 28 when the first and second connectors are joined by sliding engagement.

In use, the electrical conductor subassemblies are joined together by sliding engagement with first and second connectors of adjacent subassemblies, bringing the conductor engagement elements together, and turning to align lug 34 and notch 24. Retaining clip 50 is then installed through the combination channel formed by slot 25 and grew 35. O-ring 29 provides the seal against external fluids and the design of the connectors enables a secure connection against forces in the hole or pipe that are typically present in such situations. In trenchless construction, pressures due to pumped fluid are 10-28 psi due to the charge pumps, and 50-1200 psi or more (up to 4000 psi) due to the mud pumps that may be used to force the drilling fluid into the pipe. Consequently the forces against which the connection is designed to be secured and the electrical connection designed to be sealed include the force of pressurized fluid, preferably up to at least 10 psi, 28 psi, 50 psi, 1200 psi or 4000 psi in different embodiments. In this embodiment, the design pressure is at least 1200 psi and preferably higher.

The invention thus provides an alternative to prior art conductor strings, which has the advantages of the spliced cable sections, but also improved ease of connection compared to the six minutes required for cable splicing and joining, and resilience against torsional forces and isolation from external fluids allowing more reliable electrical connection for power and/or signal transmission. In addition, the subassemblies, unlike spliced cable segments, are reusable; and unlike the CableLink inserts, can be removed after the drill head surfaces at the end of a typical horizontal direct drilling task.

Persons skilled in the art will also appreciate that many variations may be made to the invention without departing from the scope of the invention.

For example, the details of the connectors and rigid cables of the embodiment shown here are exemplary only and may be varied to stay within the broadest scopes of the invention. Such variations can include more sophisticated locking mechanisms than the manual retaining clip 50, such as integral spring-loaded locks, and swivelling joiners to prevent twisting of long assemblies.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. An electrical conductor subassembly connectable with other of the subassemblies into a conductor string while being fed into an opening in a hole or pipe, thereby enabling an electrical connection along the conductor string that is electrically substantially isolated from external fluids in the hole or pipe, each conductor subassembly comprising:
a conductor segment with a conductor core surrounded by an insulating layer;
first and second connectors attached to opposite ends of the conductor segment, having respective first and second conductor engagement elements attached to corresponding ends of the conductor core;
wherein the first and second connectors of adjacent conductor subassemblies are connectable securely against forces in the hole or pipe and so as to electrically join the corresponding first and second conductor engagement elements and seal them from contact with the external fluids.

2. An electrical conductor subassembly as claimed in claim 1, wherein:
the hole or pipe is a drill pipe string for use in trenchless construction, the drill pipe string being constructed from drill pipe segments screwed together into the drill pipe string as a drill head bores through the earth; and
the opening is an end of a last-screwed drill pipe segment.

3. An electrical conductor subassembly as claimed in claim 2, wherein the first and second connectors when joined are prevented from relative rotation.

4. An electrical conductor subassembly as claimed in claim 2, wherein a cross-sectional area of the rigid conductor segment is substantially less than an internal cross-sectional area of the drill pipe so as not to substantially impede flow of the fluids.

5. An electrical conductor subassembly as claimed in claim 2, wherein the conductor segment is sufficiently rigid to resist tangling in use.

6. An electrical conductor subassembly as claimed in claim 2, wherein a maximum lateral dimension of the first and second connector is also substantially less than an internal cross-sectional area of the drill pipe.

7. An electrical conductor subassembly as claimed in claim 1, wherein the first and second connectors are lockable together by operation of a locking element.

8. An electrical conductor subassembly as claimed in claim 2, wherein the rigid conductor segment is a rigid or rigidified segment of cable.

9. An electrical conductor subassembly as claimed in claim 1, further comprising an o-ring seal disposed in the first or second connector to seal the conductor engagement elements from the outside fluids.

10. An electrical conductor subassembly as claimed in claim 1, wherein the conductor core is suitable for transmitting electrical power and/or receiving data signals from a device attached at a distal end of the conductor string.

11. An electrical conductor subassembly as claimed in claim 2, wherein the conductor core is suitable for transmitting electrical power and/or receiving data signals from a drill head attached at a distal end of the conductor string.

12. An electrical conductor subassembly as claimed in claim 2, wherein a length of the subassembly is substantially the same as a length of each drill pipe segment, to allow connection of the subassembly to the conductor string as each drill pipe segment is screwed into the drill pipe.

13. An electrical conductor subassembly as claimed in claim 8, wherein the drill pipe segments have an internal diameter of less than 200 mm, the length of each drill pipe segment is less than 10 m, and the rigid conductor segment comprises a rigid cable having a diameter of less than 20 mm.

14. A method of constructing an isolated electrical connection comprising a set of the connected electrical conductor subassemblies of claim 2 to a device in a drill pipe for use in trenchless construction, the method comprising the steps of comprising joining and locking together the first and second connectors of adjacent subassemblies to form the conductor string.

15. A method of constructing an isolated electrical connection comprising a set of the connected electrical conductor subassemblies of claim 2 to a device in a drill pipe for use in trenchless construction, the method comprising the steps of:
connecting at least a first one of the subassemblies to the device so that a rearmost connector of the first subassembly is accessible from the end of a last-screwed drill pipe segment;
operating the drill until a new drill pipe segment needs to be screwed into the drill pipe string;
connecting at least a further one of the subassemblies by connecting the appropriate connectors of the further subassembly to the rearmost connector of the first subassembly;
screwing the new drill pipe segment into the drill pipe string so as to encompass the further subassembly and so that a rearmost connector of the conductor string thus formed is accessible from the open end of the new drill pipe segment; and
repeating the steps of operating the drill, connecting a further one of the subassemblies and screwing the new drill pipe segment as required.
